(19) United States
(12) Patent Application Publication
(10) Pub. No.: US 2018/0090132 A1
(43) Pub. Date: Mar. 29, 2018

(54) VOICE DIALOGUE SYSTEM AND VOICE DIALOGUE METHOD

(71) Applicant: TOYOTA JIDOSHA KABUSHIKI KAISHA, Toyota-shi (JP)

(72) Inventors: Atsushi IKENO, Kyoto-shi (JP); Muneaki SHIMADA, Nerima-ku (JP); Kota HATANAKA, Kama-shi (JP); Toshifumi NISHIJIMA, Kasugai-shi (JP); Fuminori KATAOKA, Nisshin-shi (JP); Hiromi TONEGAWA, Okazaki-shi (JP); Norihide UMEYAMA, Nisshin-shi (JP)

(73) Assignee: TOYOTA JIDOSHA KABUSHIKI KAISHA, Toyota-shi (JP)

(21) Appl. No.: 15/704,518

(22) Filed: Sep. 14, 2017

(30) Foreign Application Priority Data
Sep. 28, 2016 (JP) 2016-189382

(51) Int. Cl. G10L 15/18; G10L 13/00; G10L 15/22; G10L 15/30

(52) U.S. Cl. CPC G10L 15/1815; G10L 15/30; G10L 15/22; G10L 13/00

(57) ABSTRACT

A voice dialogue system includes a dialogue scenario storage storing a plurality of dialogue scenarios and a dialogue text generator generating a dialogue text for responding to a user utterance based on a result of voice recognition. The dialogue scenario is a single set of three contents: a content of a first system utterance, a content of an expected user utterance, and a content of a second system utterance for responding to the expected user utterance. The dialogue text generator determines whether or not the user utterance is an expected response and, when the user utterance is an expected response, generates a second system utterance defined in a dialogue scenario as a response to the user utterance as a dialogue text for responding to the user utterance.

### BACKGROUND OF THE INVENTION

### Field of the Invention

The present invention relates to a voice dialogue system.

### Description of the Related Art

In a voice dialogue system, desirably, a naturally-flowing dialogue can be carried out with a user.

Japanese Patent Application Laid-open No. 2014-98844 proposes interpreting an intention of a user utterance to determine whether or not the intention is to request a search for information. This determination is made based on whether or not a prescribed character string is included in a sentence. When the intention of the user utterance is to search for information, information is searched using an external search engine and a search result is acquired. On the other hand, when the intention of the user utterance is not to search for information, idle conversation data in accordance with the utterance is extracted from idle conversation data determined in advance.

Japanese Patent Application Laid-open No. 2001-175657 discloses, with respect to sentences included in a document written in a natural language, performing association between sentences, between words, and between sentences and words and storing association information in a conversation database. When a question sentence in a natural language is inputted from a user, a degree of similarity between sentences accumulated in the conversation database and the input question sentence is calculated and a sentence with a high degree of similarity is selected as a reply sentence.

Although both Japanese Patent Application Laid-open No. 2014-98844 and Japanese Patent Application Laid-open No. 2001-175657 are designed to determine a response sentence with respect to an utterance made by a user, since a response is determined based on a single utterance made by the user, there are cases where an appropriate system response cannot be determined. For example, when the user simply replies YES or NO, continuing a conversation may become difficult.

Patent Document 1: Japanese Patent Application Laid-open No. 2014-98844

Patent Document 2: Japanese Patent Application Laid-open No. 2001-175657

### SUMMARY OF THE INVENTION

An object of the present invention is to provide a voice dialogue system capable of picking up the meaning and returning a response even when an utterance by a user is a short word.

A first aspect of the present invention is a voice dialogue system including:

a voice recognizer configured to acquire a result of voice recognition of a user utterance;

a dialogue scenario storage configured to store a plurality of dialogue scenarios; and

a dialogue text generator configured to generate a dialogue text for responding to the user utterance, based on the result of voice recognition, wherein

the dialogue scenario is a single set of three contents, which are a content of a first system utterance, a content of a user utterance expected as a response to the first system utterance, and a content of a second system utterance that is a response to the expected user utterance, and

the dialogue text generator is configured to determine whether or not the user utterance is an expected response to a last system utterance and, in response to a determination that the user utterance is the expected response, generate a response to the user utterance based on a second system utterance that is defined in a dialogue scenario as a dialogue text for responding to the expected utterance.

According to such a configuration, since a dialogue scenario (a conversation template) is used, a natural response which also takes content of a last system utterance into consideration can be returned regardless of whether a user utterance is short or long.

In a single dialogue scenario, a plurality of expected user utterances for the first system utterance may be defined. In this case, the content of second system utterances are respectively registered in accordance with the content of the user utterances. Therefore, with respect to a same system utterance, a second response by the system can be readily differentiated in accordance with a response by the user.

In the present invention, when the user utterance is not an expected response to a last system utterance, the dialogue text generator may select any of a plurality of dialogue scenarios stored in the dialogue scenario storage and generate the content of a first system utterance in the selected dialogue scenario as a dialogue text for responding to the user utterance. In doing so, it is also favorable to select the dialogue scenario by taking into consideration at least one of a conversation topic of a previous conversation, current circumstances (scene), and an emotion of the user. In order to enable such selections to be made, the dialogue scenario storage may store a conversation topic of a conversation, circumstances, and an emotion of the user in association with a dialogue scenario.

In addition, in the present invention, when a user utterance is acquired after selecting a dialogue scenario, generating a dialogue text, and outputting voice, the determination of whether or not the user utterance is the expected response to a last system utterance may be made based on whether or not the user utterance is stored as an expected response in the selected dialogue scenario.

Furthermore, in the present invention, the dialogue scenario storage may store a different dialogue scenario including, as the content of a first system utterance, the content of a second system utterance in at least a part of dialogue scenarios. While a dialogue longer than three utterances may conceivably be defined in a single dialogue scenario, a dialogue scenario can be readily managed by preparing a plurality of scenarios including three utterances and performing a dialogue by splicing the plurality of scenarios.

Moreover, the present invention can be considered a voice dialogue system including at least a part of the units/modules described above. The present invention can also be considered a voice dialogue apparatus or a dialogue server constituting a voice dialogue system. In addition, the present invention can also be considered a voice dialogue method which executes at least a part of the processes described above. Furthermore, the present invention can also be considered a computer program that causes the method to be executed by a computer or a computer-readable storage medium that non-transitorily stores the computer program. The respective units and processes described above can be combined with one another to the greatest extent possible to constitute the present invention.

According to the present invention, in a voice dialogue system, the meaning of a user utterance can be picked up and a response can be returned even when the user utterance is a short word.

### BRIEF DESCRIPTION OF THE DRAWINGS

FIG. 1 is a diagram showing a configuration of a voice dialogue system according to an embodiment;

FIG. 2 is a diagram showing a configuration of a voice dialogue system according to a modification;

FIGS. 3A and 3B are diagrams showing an example of a dialogue scenario;

FIG. 4 is a diagram showing a flow of processing in a voice dialogue system according to an embodiment; and

FIG. 5 shows an example of a dialogue between a user and a system according to an embodiment.

### DESCRIPTION OF THE EMBODIMENTS

An embodiment of the present invention will now be exemplarily described in detail with reference to the drawings. While the embodiment described below is a system in which a voice dialogue robot is used as a voice dialogue terminal, a voice dialogue terminal need not be a robot and any type of information processing apparatus, a voice dialogue interface, and the like can be used.

### System Configuration

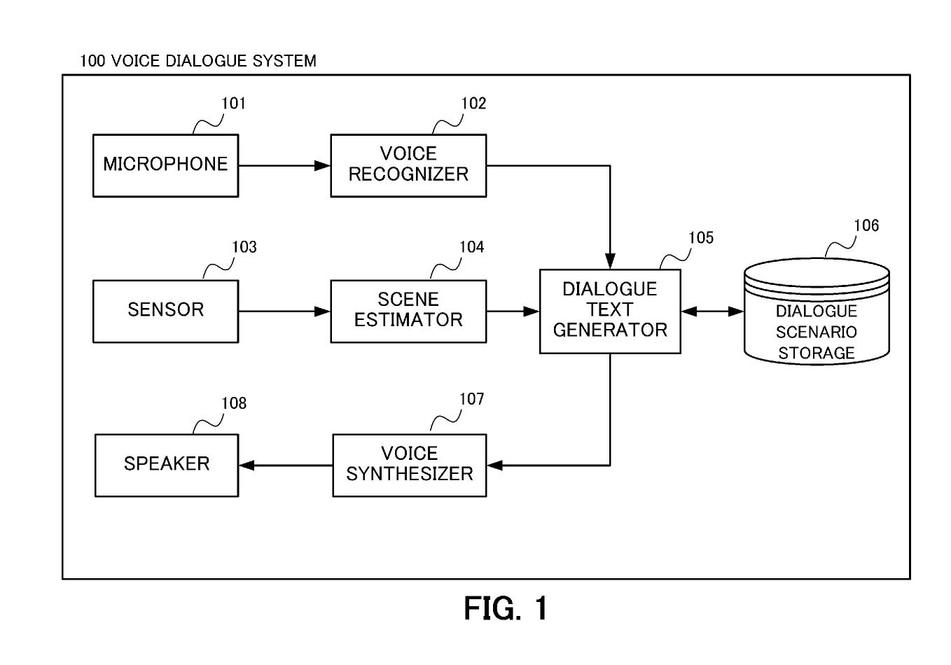

FIG. 1 is a diagram showing a configuration of a voice dialogue system (a voice dialogue robot) according to the embodiment. A voice dialogue robot 100 according to the embodiment is a computer including a microphone 101, a sensor 103, a speaker 108, a processing unit such as a microprocessor, a memory, and a communication apparatus. When the microprocessor executes a program, the voice dialogue robot 100 functions as a voice recognizer 102, a scene estimator 104, a dialogue text generator 105, a dialogue scenario storage 106, and a voice synthesizer 107. Although not shown, the voice dialogue robot 100 may include an image acquisition apparatus (camera), movable joints, and moving mechanism.

The voice recognizer 102 performs processing such as noise elimination, sound source separation, and feature extraction with respect to voice data of a user utterance input from the microphone 101 and converts the content of the user utterance into a text. The voice recognizer 102 estimates a conversation topic based on the content of a user utterance and estimates an emotion of a user based on the content or a voice feature of the user utterance.

The scene estimator 104 estimates a current scene based on sensor information obtained from the sensor 103. The sensor 103 may be of any type as long as peripheral information can be acquired. For example, a GPS sensor for acquiring positional information can be used to determine whether the current scene represents staying at home, working at the office, visiting a tourist destination, or the like. Otherwise, the current scene may be estimated using a clock (time point acquisition), a luminance sensor, a rainfall sensor, a velocity sensor, an acceleration sensor, or the like as the sensor 103.

The dialogue text generator 105 determines content of a system utterance to be uttered to the user. Typically, the dialogue text generator 105 generates a dialogue text based on the content of a user utterance or a conversation topic of a current conversation, an emotion of the user, a current scene, and the like.

The dialogue text generator 105 determines a dialogue text by referring to a conversation template (a dialogue scenario) stored in the dialogue scenario storage 106. A conversation template is a single set of three utterances, namely, (1) a system utterance, (2) a user utterance expected as a response to the system utterance, and (3) a system utterance for responding to the expected user utterance. When a response obtained from the user after making an utterance in accordance with the conversation template is an expected response to a first system utterance, the dialogue text generator 105 determines a system response defined in the conversation template as a dialogue text for a response to the user utterance. Details will be explained later.

The voice synthesizer 107 receives a text of an utterance content from the dialogue text generator 105 and performs voice synthesis to generate response voice data. The response voice data generated by the voice synthesizer 107 is reproduced from the speaker 108.

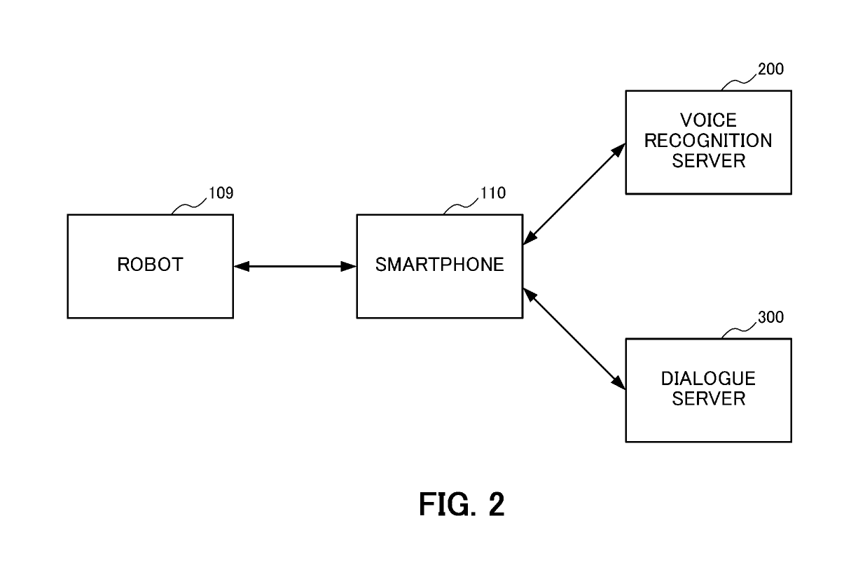

Moreover, the voice dialogue robot 100 need not be configured as a single apparatus. For example, as shown in FIG. 2, a two-apparatus configuration can be adopted with a robot apparatus 109 (a front end apparatus) including the microphone 101, the sensor 103, the speaker 108, a camera, and movable joints and a smartphone 110 (or another computer) which executes various processing. In this case, the robot apparatus and the computer are connected by wireless communication such as Bluetooth (registered trademark), data acquired by the robot apparatus is sent to the computer, and reproduction of a response sentence or the like is performed by the robot apparatus based on a result of processing by the computer.

In addition, the voice recognition process and the dialogue text generation process need not be performed by the voice dialogue robot 100 and, as shown in FIG. 2, the processes may be performed by a voice recognition server 200 and a dialogue server 300. Alternatively, the processes may be performed by a single server. When the processes are performed using an external server in this manner, the smartphone 110 (or the robot apparatus 109) controls cooperation with the server.

### Dialogue Scenario (Conversation Template)

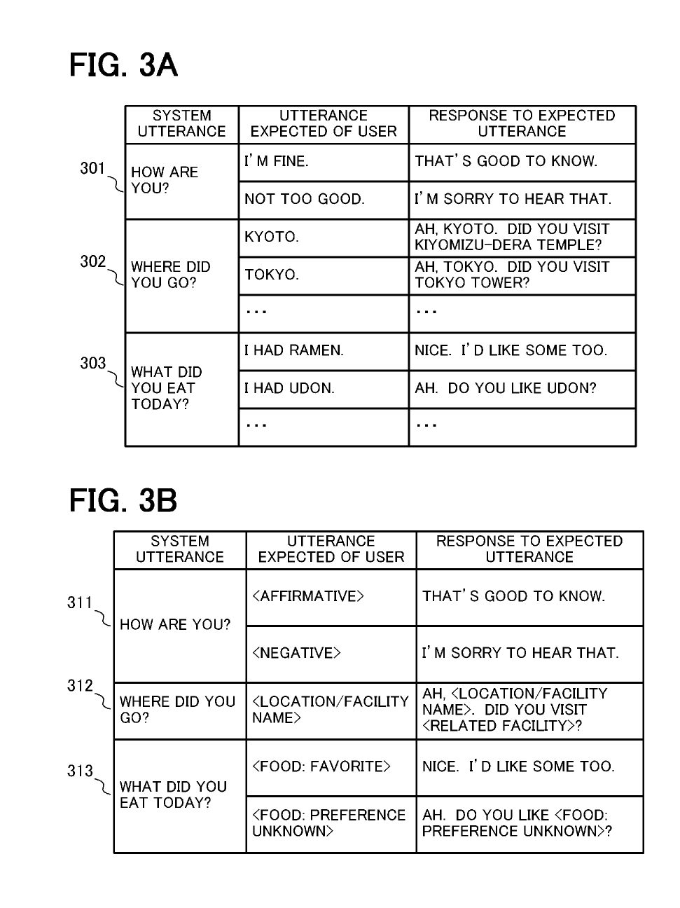

FIG. 3A is a diagram showing an example of a dialogue scenario according to the present embodiment. For example, a field 301 defines a dialogue scenario in which, with respect to an utterance made by the system of “How are you?”, when the user replies “I'm fine”, the system further responds “That's good to know”, but when the user replies “Not too good”, the system further responds “I'm sorry to hear that”.

A field 302 represents a dialogue scenario in which, with respect to a system utterance of “Where did you go?”, when the user replies “Kyoto”, the system further responds “Ah, Kyoto. Did you visit Kiyomizu-dera Temple?”, but when the user replies “Tokyo”, the system further responds “Ah, Tokyo. Did you visit Tokyo Tower?” A field 303 represents a dialogue scenario in which, with respect to a system utterance of “What did you eat today?”, when the user replies “I had ramen”, the system further responds “Nice. I'd like some too”, but when the user replies “I had udon”, the system further responds “Ah. Do you like udon?”

Since individually defining such dialogue scenarios is time-consuming, in the present embodiment, a dialogue scenario is represented by a conversation template using attribute information of words or sentences and stored in the dialogue scenario storage 106.

FIG. 3B shows an example of a dialogue scenario using a conversation template. A field 311 represents a conversation template corresponding to the dialogue scenario in the field 301 which defines, with respect to a system utterance of “How are you?”, when the user returns an affirmative response, the system further responds “That's good to know”, but when the user returns a negative response, the system further responds “I'm sorry to hear that”. In this case, <affirmative> or <negative> is attribute information indicating that a response sentence of the user represents affirmation or negation as a whole. Affirmative sentences include “I'm fine”, “Never been better”, “Yes”, and “Yeah”, and negative sentences include “Not too good”, “No good”, and “No”.

A field 312 represents a conversation template corresponding to the dialogue scenario in the field 302. With respect to a system utterance of “Where did you go?”, when the user makes a response related to a location or a facility name, the system repeats the location or facility name uttered by the user and further asks whether or not the user had visited a location related to the uttered location or facility. A related location can be acquired by having the dialogue text generator 105 refer to a database.

A field 313 represents a conversation template corresponding to the dialogue scenario in the field 303. With respect to a system utterance of “What did you eat today?”, when the user replies that he/she had eaten one of his/her favorite foods, the system responds “Nice. I'd like some too”, but when the user replies that he/she had eaten a food which the system has no knowledge as to whether the user likes the food or not, the system asks the user whether he/she likes the food. In this case, whether or not a food included in a user utterance is a favorite of the user can be determined by referring to a database storing user information.

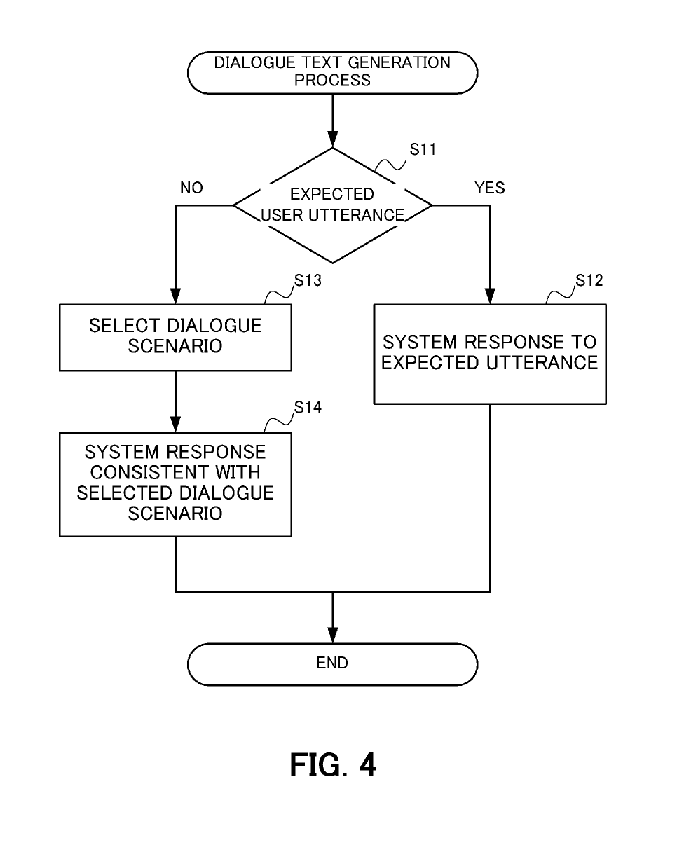

FIG. 4 is a flow chart showing a flow of a dialogue text generation process according to the present embodiment. Processing in a case where the voice dialogue system generates a response after receiving an utterance from the user will now be described.

In step S11, the dialogue text generator 105 acquires a recognition result of a user utterance from the voice recognizer 102 and determines whether or not the utterance by the user is an expected response.

Cases where the voice dialogue system makes an utterance in accordance with a given dialogue scenario and the user returns a response which is defined as an expected response in the dialogue scenario correspond to the user utterance being an expected response (S11—YES). For example, when the voice dialogue system asks the user “Where did you go?” in accordance with the dialogue scenario in the field 312 in FIG. 3B, a case where the user answers with a location or a facility name corresponds to an expected response.

When the user utterance is an expected response (S11—YES), in step S12, the dialogue text generator 105 determines a response defined in the dialogue scenario as a system response. In the example described above, a question on whether or not the user had visited a location related to the location or the facility name responded by the user (“Ah, <location/facility name>. Did you visit <related location>?”) is determined as the system response.

On the other hand, any response other than the above corresponds to the user utterance not being an expected response (S11—NO). In other words, cases where the voice dialogue system makes a system utterance in accordance with a given dialogue scenario and the user returns a response other than a response which is defined as an expected response in the dialogue scenario correspond to the user utterance not being an expected response. In addition, cases where the user spontaneously talks to the system instead of making an utterance in response to an utterance by the system also correspond to the user utterance not being an expected response. When the user utterance is not an expected response (S11—NO), in step S13, the dialogue text generator 105 newly selects a dialogue scenario to be adopted based on the content of the user utterance, an estimated scene, or the like. In step S14, the dialogue text generator 105 determines an utterance content in the selected dialogue scenario as a system response. Moreover, which dialogue scenario is selected is stored in a storage unit.

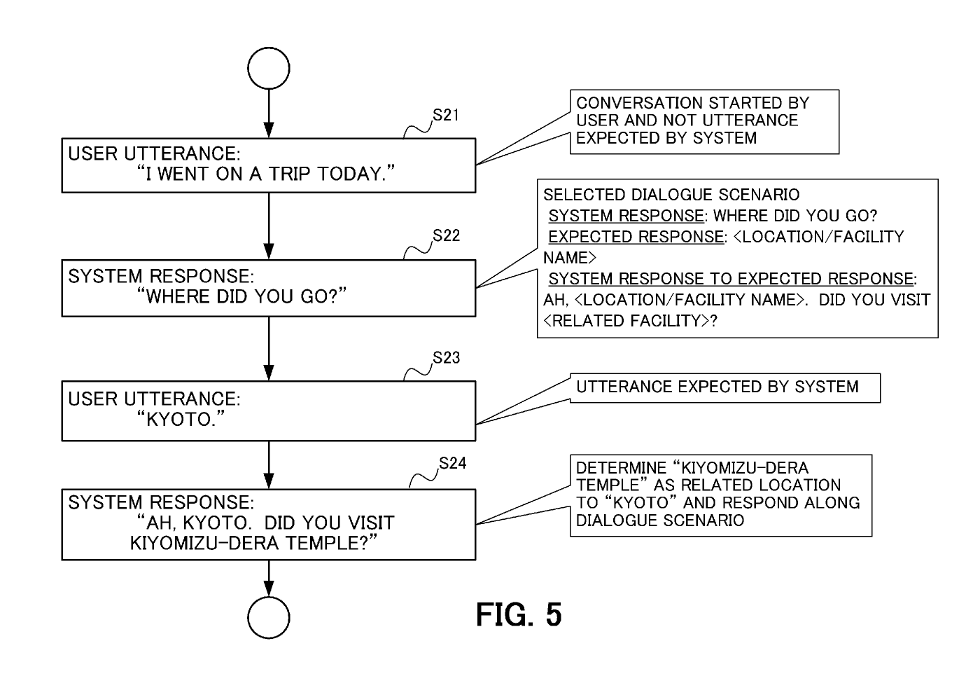

FIG. 5 shows an example of a dialogue which takes place between the system and the user according to the present embodiment. First, in step S21, the user tells the system “I went on a trip today”. A conversation is started by this utterance made by the user but, at this point, the system has not yet started a dialogue based on a dialogue scenario. Therefore, the user utterance in step S21 does not correspond to a response expected by the system (S11—NO).

In this case, in step S22, the dialogue text generator 105 considers the content of the user utterance and selects an appropriate dialogue scenario (the field 312 in FIG. 3B) as a response thereto, and makes an utterance of “Where did you go?” (S13 and S14).

In response thereto, in step S23, the user answers “Kyoto”. This response corresponds to an expected response (<location/facility name>) in the dialogue scenario (S11—YES). Therefore, the dialogue text generator 105 adopts a response (“Ah, <location/facility name>. Did you visit <related location>?”) defined in the current dialogue scenario as a response. In doing so, “Kyoto” included in the user utterance is substituted without modification into <location/facility name> and “Kiyomizu-dera Temple” which is determined as a location related to “Kyoto” is substituted into <related location>. Subsequently, in step S24, a system response of “Ah, Kyoto. Did you visit Kiyomizu-dera Temple?” is returned (S12).

Moreover, when the user utterance in step S23 is “I got home at night”, the user utterance is not an expected response in the dialogue scenario (S11—NO). In this case, instead of adopting the response of “Ah, <location/facility name>. Did you visit <related location>?” defined in the current dialogue scenario, the dialogue text generator 105 once again makes a selection from all dialogue scenarios (conversation templates) and makes an utterance defined in the selected dialogue scenario (S13 and S14).

### Advantageous Effects of Embodiment

According to the present embodiment, since a dialogue consistent with a dialogue scenario is performed, even when a user's response to a system utterance is short, a natural response which takes the content of an initial system utterance into consideration can be returned.

In addition, since a dialogue scenario is managed as a set of three utterances, there is an advantage that a dialogue scenario database can be readily generated and managed.

Furthermore, by preparing a different dialogue scenario which uses a third utterance in a given dialogue scenario as a first utterance, a long dialogue which splices a plurality of dialogue scenarios can be made. When a response expected of the user in a given dialogue scenario is obtained, the dialogue text generator 105 may determine a response defined in the dialogue scenario as an utterance sentence, select a different dialogue scenario defining the utterance sentence as a first utterance, and re-store the different dialogue scenario as the dialogue scenario currently being used.

### Modifications

The dialogue scenarios described above are merely examples and various modifications can be adopted. For example, while a dialogue scenario is defined by only considering wording (text) of a user utterance, responses to be returned may be differentiated in accordance with an emotion of the user. For example, a dialogue scenario can also be defined so that a different system response is returned depending on whether the user seems happy, sad, or the like even when the user makes a same response to questions such as “Where did you go?” and “What did you eat?”. In a similar manner, a dialogue scenario can also be defined so that a system response is returned in accordance with circumstances (scene) that the user is in.

### Other

The configurations of the embodiment and the modification described above can be used appropriately combined with each other without departing from the technical ideas of the present invention. In addition, the present invention may be realized by appropriately making changes thereto without departing from the technical ideas thereof.

What is claimed is:

1. A voice dialogue system, comprising:
a voice recognizer configured to acquire a result of voice recognition of a user utterance;
a dialogue scenario storage configured to store a plurality of dialogue scenarios; and
a dialogue text generator configured to generate a dialogue text for responding to the user utterance, based on the result of voice recognition, wherein
the dialogue scenario is a single set of three contents, which are a content of a first system utterance, a content of a user utterance expected as a response to the first system utterance, and a content of a second system utterance that is a response to the expected user utterance, and
the dialogue text generator is configured to determine whether or not the user utterance is an expected response to a last system utterance and, in response to a determination that the user utterance is the expected response, generate a response to the user utterance based on a second system utterance that is defined in a dialogue scenario as a dialogue text for responding to the expected utterance.

2. The voice dialogue system according to claim 1, wherein, in response to a determination that the user utterance is not an expected response to a last system utterance, the dialogue text generator selects any of a plurality of dialogue scenarios stored in the dialogue scenario storage and generates a content of a first system utterance in the selected dialogue scenario as a dialogue text for responding to the user utterance.

3. The voice dialogue system according to claim 2, wherein, when a user utterance is acquired after selecting a dialogue scenario, generating a dialogue text, and outputting voice, the determination of whether or not the user utterance is the expected response is made based on whether or not the user utterance is stored as an expected response in the selected dialogue scenario.

4. The voice dialogue system according to claim 1, wherein the dialogue scenario storage is configured to store a different dialogue scenario including, as the content of the first system utterance, the content of the second system utterance in at least a part of dialogue scenarios.

5. A voice dialogue method, comprising:
acquiring a result of voice recognition of a user utterance; and
generating a dialogue text for responding to the user utterance, based on the result of voice recognition, wherein
the generation of a dialogue text involves:
generating a dialogue text by referring to a dialogue scenario defined as a single set of three contents, which are a content of a first system utterance, a content of a user utterance expected as a response to the first system utterance, and a content of a second system utterance that is a response to the expected user utterance;
determining whether or not the user utterance is an expected response to a last system utterance; and
generating, in response to a determination that the user utterance is the expected response, a response to the user utterance based on a second system utterance that is defined in a dialogue scenario as a dialogue text for responding to the user utterance.

6. The voice dialogue method according to claim 5, wherein, generating the dialog text for responding to the user utterance includes, in response to a determination that the user utterance is not an expected response to a last system utterance, selecting any of a plurality of dialogue scenarios stored in a dialogue scenario storage and generating a content of a first system utterance in the selected dialogue scenario as a dialogue text for responding to the user utterance.

7. The voice dialogue method according to claim 6, wherein, when a user utterance is acquired after selecting a dialogue scenario, generating a dialogue text, and outputting voice, the determination of whether or not the user utterance is the expected response is made based on whether or not the user utterance is stored as an expected response in the selected dialogue scenario.

8. The voice dialogue method according to claim 5,
wherein a plurality of dialog scenarios are referred to in generating the dialog text for responding to the user utterance, and
wherein the plurality of dialog scenarios comprises a different dialogue scenario including, as the content of the first system utterance, the content of the second system utterance in at least a part of dialogue scenarios.

9. A computer-readable medium non-transitorily storing a program for causing a computer to execute the respective steps of the method according to claim 5.
